(19) United States
(12) Patent Application Publication
(10) Pub. No.: US 2006/0089906 A1
(43) Pub. Date: Apr. 27, 2006

(54) Method for securing a payment transaction over a public network

(76) Inventor: Michael Rowley, Toronto (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/968,980

(22) Filed: Oct. 21, 2004

(51) Int. Cl. G06Q 40/00

(52) U.S. Cl. 705/40

(57) ABSTRACT

A method for processing a payment transaction between a buyer and a seller over a network using a payment manager is provided. The payment manager manages a plurality of buyer and seller accounts, each account having an account id associated with it. The payment manager receives payment authorization requests for payment transactions, including a payment amount and an identification of a seller. The buyer provides an account id and a location identification to the payment manager, so that the payment manager may determine whether the buyer is communicating over a secure network. If buyer communicates over a secure network, the payment manager requests that the buyer provides a security code to confirm the transaction. If the location identification indicates that the buyer communicates over an insecure network, the payment manager requesting that the buyer answers at least one security question to confirm the transaction. If the confirmation is correct, the payment manager authorizing the payment transaction and sending confirmation to the seller. The security code is used repeatedly for confirmation of all payment transactions for which the location identification indicates that the network is secure, and the security question is repeated randomly for some payment transactions for which the location identification indicates that the network is insecure.

### FIELD OF THE INVENTION

The invention relates to a method for communicating over a public network. More specifically, it relates to a method for carrying out a secure credit card payment transaction over a public network.

### BACKGROUND OF THE INVENTION

The past few years have seen many new developments with the internet. The use of websites for information, company profiles, and job applications has proliferated. In addition, the use of the internet as a method for directly selling to customers has experienced considerable growth. However, e-commerce activities require that customers provide payment information, most often credit card details, over highly insecure communication networks, leaving the possibility for fraud and abuse.

A great number of people are justifiably concerned about the security of the internet; namely, that if they use their credit-cards for transactions via the internet, they risk having their credit-card information intercepted by unscrupulous interests, or, that their credit-card information, once stored in a corporation's computer system could be vulnerable to a hacker's actions and result in their credit-card information being exploited for the purposes of fraud. On the other side of the coin, the banks and their credit-card operations are contending with a great amount of costly fraud because of credit-cards, the internet, and their lack of security.

Due to these disadvantages, it has become obvious that the credit card system is not well suited for carrying financial transactions over public networks, such as the Internet.

There exists therefore a need for an improved way of securing the exchange of payment information when carrying out a payment transaction over a public network.

### SUMMARY OF THE INVENTION

Accordingly, an object of the present invention is to provide a method for processing a payment transaction between a buyer and a seller which reduces the possibility of fraud by avoiding that credit card information details are exchanged over the public network.

According to a first broad aspect of the present invention, there is provided a method for processing a payment transaction between a buyer and a seller over a network using a payment manager, the payment manager managing a plurality of buyer accounts, each account identifying a payment modality and having an account id: the payment manager receiving a payment authorization request for the payment transaction, including a payment amount and an identification of the seller; the buyer providing an account id and a location identification to the payment manager; the payment manager using the location identification to determine whether the buyer is at home; if the location identification indicates that the buyer is at ‘home’: the payment manager requesting that the buyer provides a security code to confirm the transaction; the buyer providing the security code in a secure manner to the payment manager as confirmation; if the location identification indicates that the buyer is ‘away: the payment manager requesting that the buyer answers at least one security question to confirm the transaction; the buyer sending the payment manager the answer to the security question as confirmation; and if the confirmation is correct, the payment manager authorizing the payment transaction and sending confirmation to the seller, wherein the security code is used repeatedly for confirmation of all payment transactions for which the location identification indicates that the buyer is at ‘home’, and the at least one security question is used for payment transactions for which the location identification indicates that the buyer is ‘away’.

### BRIEF DESCRIPTION OF THE DRAWINGS

These and other features, aspects and advantages of the present invention will become better understood with regard to the following description and accompanying drawings wherein:

FIG. 1 is a block diagram of a system according to the preferred embodiment of the present invention;

FIG. 2 is a block diagram of a buyer making a purchase over a secure connection according to the preferred embodiment of the present invention;

FIG. 3 is a block diagram of a buyer making a purchase over an insecure network connection according to the preferred embodiment of the present invention;

FIG. 4 is a flow chart of a method for processing a payment transaction between a buyer and a seller according to the preferred embodiment of the present invention;

FIG. 5 is a block diagram of a buyer making a purchase over a secure network connection according to an alternative embodiment of the present invention;

FIG. 6 is a block diagram of a buyer making a purchase over an insecure network connection according to an alternative embodiment of the present invention.

### DETAILED DESCRIPTION OF THE PREFERRED EMBODIMENT

A preferred embodiment of the present invention will now be described in detail.

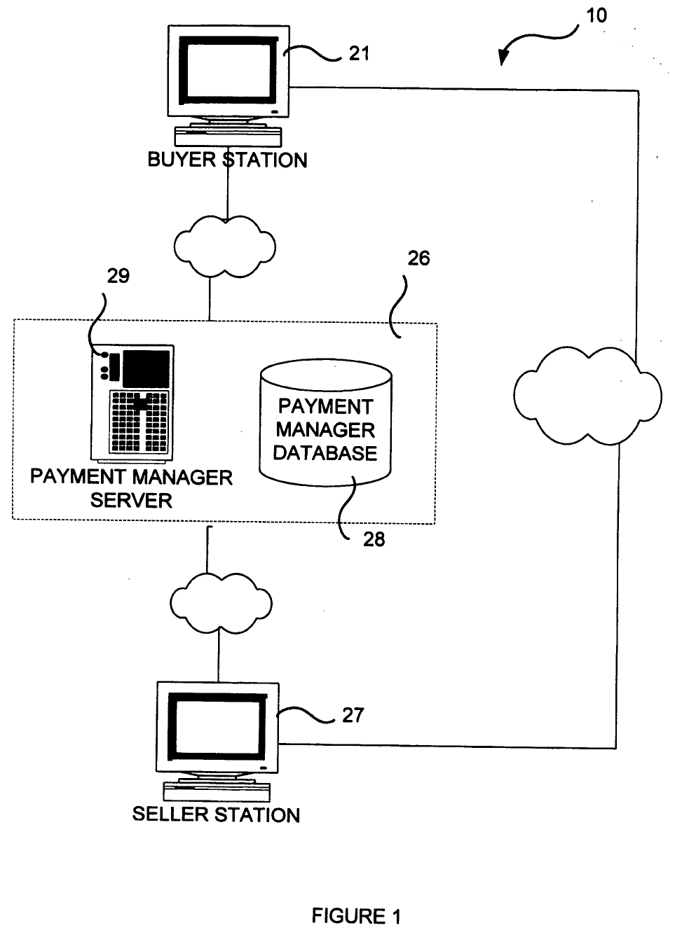

Referring to FIG. 1, the preferred embodiment of the system 10 contains two computer-based stations 21, 27 communicating with each other through a public network, such as the Internet. In this embodiment, for exemplary purposes, only one buyer station 21 and one seller station 27 are shown, although a plurality of buyer stations 21 could communicate with a plurality of selling stations 27 as part of the same system 10. The stations 21, 27 communicate via any suitable transmission media, such as an ordinary public telephone line, a data quality line, a radio link or any other transmission media suitable for inter-computer communication.

An exemplary computer system used at the buyer station may comprise: a computer, an input system including a keyboard and a mouse, a display device, a digital camera, a document scanning device, a communication control device for communication with the network and possibly an external storage device. The computer includes a central processor unit (CPU), a read only memory (ROM), a random access memory (RAM) and an internal storage device. The software running at the buyer station 21 may reside on an external storage device or an internal one.

In the preferred embodiment of the present invention, the payment manager 26 includes a payment manager server 29 and a payment manager database 28. The server 29 receives all requests for payment authorization, from buyer or seller stations 21, 27 and ensures security of the transactions by implementing various security protocols. The server 29 uses the information stored on the payment manager database 28, which includes account details for all of its subscribers. The account details may include user account ID, password, PIN, payment accounts, security questions and their associated answers, etc. In one embodiment of the present invention, the database 28 resides directly on the payment manager server 29. In the preferred embodiment of the present invention, the payment manager server 29 is a secure server protected by firewall and encryption technologies in order to ensure security of the information stored in the database 28. The payment manager 26 uses a web-interface to provide access to user accounts for registration and modifications.

In a preferred embodiment, the buyer station 21 is a computer platform running, for example, client software or a web-based application, and is in connection with a payment manager 26.

In the preferred embodiment of the present invention, the buyer station 21 is located either at ‘home’ or ‘away’. In the case in which the buyer station 21 is located at the buyer's home, it is assumed that the buyer station 21 communicates with the payment manager 26 over a secure communication link using encryption security software that is installed on the buyer station 21 and which is registered with the payment manager 26. While in the description of the preferred embodiment, reference is made to a home location, it should be understood that ‘home’ refers to any other physical/geographical location, at which the buyer 31 communicates over a secure network.

Similarly, a buyer station 21 at an ‘away’ location designates a station communicating over an insecure network. Examples of remote locations include a library public terminal, a terminal in a hotel, an Internet café station, etc.

A user at the buyer station 21 may access the system by using any commercially available Internet web browser, such as Microsoft Internet Explorer™ or Netscape Navigator™. Any terminal with web-browsing abilities, such as a personal computer, a web-enhanced cellular phone or a personal digital assistant may be used. Upon requesting the Uniform Resource Locator (URL) address corresponding to the payment manager website, a home page is loaded in the browser, requesting the user's identification credentials (typically a username and password). Access to the payment manager 26 contents can be controlled using a variety of security mechanisms, including 128-bit SSL encryption. The user will provide their credentials and will send the data to the payment manager 26, by clicking on a ‘submit’-type button. An authentication process takes place on the payment manager server 29 side, during which the supplied credentials are checked against a list of registered users. If the provided credentials result in an exact match, another page is loaded into the user's browser. This page contains information regarding the buyer account, for which the username and password were provided, and more precisely, information regarding the buyer's identity, coordinates, such as billing/shipping address, PIN associated with the account, a password associated with the account, a set of security questions, as well as their ‘correct’ answers, etc. The buyer account also contains payment account details provided by the buyer 31, such as a credit card account number, a debit bank account number and associated code or a pre-paid account. In the preferred embodiment of the present invention, the buyer can specify a set of payment rules governing the use of different payment account for different payment transactions. For example, the buyer 31 could specify that certain purchases, such as books, be debited to the specified bank account, while other purchases, such as airline tickets, be charged to a credit card account.

Additionally, the buyer 31 provides to the payment manager 26 at the time of registration, a copy of the digital ID certificate that it uses in conjunction with a local email software. The digital ID certificate allows to authenticate any email transactions between the buyer 31 and the payment manager 26. When the payment manager receives information by email from a buyer 31 which does not contain the correct digital ID certificate, the payment manager 26 considers the transaction to be insecure and treats it as a transaction in the ‘away’ mode.

A user at a seller station 27 will follow a similar procedure to register with the payment manager 26. As a result seller e-commerce web sites will provide to buyers the possibility of carrying out a payment transaction through the payment manager 26. This way, when communicating with the seller, buyers do not have to disclose credit card number information or other potentially sensitive information over communication networks whose security is not guaranteed.

An example of a typical transaction using the method of the present invention will now be described. In a first step, the buyer at the buyer station 21 visits an ecommerce web site of a seller and checks out with a shopping cart including a list of products and their prices. When the web site requires that the buyer specify a payment method, the buyer selects the payment manager 26 and specifies the buyer account ID to which the transaction should be charged. The payment manager 26 is available as a payment option on all seller web sites which have previously registered with the payment manager 26. Other information that is provided to the payment manager is a confirmation of location indicating whether the buyer is shopping from the buyer station 21 connected to a secure communication network, or a different station which is not communicating over a secure network.

The seller then provides the payment manager 26 with the transaction details, such as the buyer account ID, the amount of the purchase and the products purchased, the time at which the purchase took place, and a location identification indicating whether the buyer is at ‘home’ or ‘away’, etc. If the location identification indicates that the buyer station 21 as communicating over a secure network, as seen in FIG. 3, the payment manager 26 proceeds to send an e-mail request to the buyer 31, requesting that the buyer 31 provides a security code associated with the buyer account ID, in order to confirm the transaction. In the preferred embodiment of the present invention, the security code is a PIN specified by the buyer 31 at the time of the initial registration with the payment manager 26. Since it has been determined by the payment manager 26 that the buyer 31 communicates over a secure network, it is considered safe that the buyer 31 provide the PIN by email. The PIN is provided in an encrypted email with the digital ID certificate for authentication of the buyer, over the secure communication network to the payment manager 26. Preferably, the buyer 31 is allowed a 24-hour time interval during which it may provide the PIN, after which the transaction would be cancelled.

The payment manager receives the encrypted email with the digital ID certificate and authenticates the buyer 31. Then, the payment manager 26 checks whether the provided PIN is correct. If so, the payment manager 26 authorizes the payment transaction by sending a transaction clearance to the bank associated with the buyer account. The bank approves the transaction and sends an authorization number to the payment manager 26, which then forwards it to the seller 33. Preferably, a confirmation email is sent by the seller 33 to the buyer 31 upon completion of the transaction.

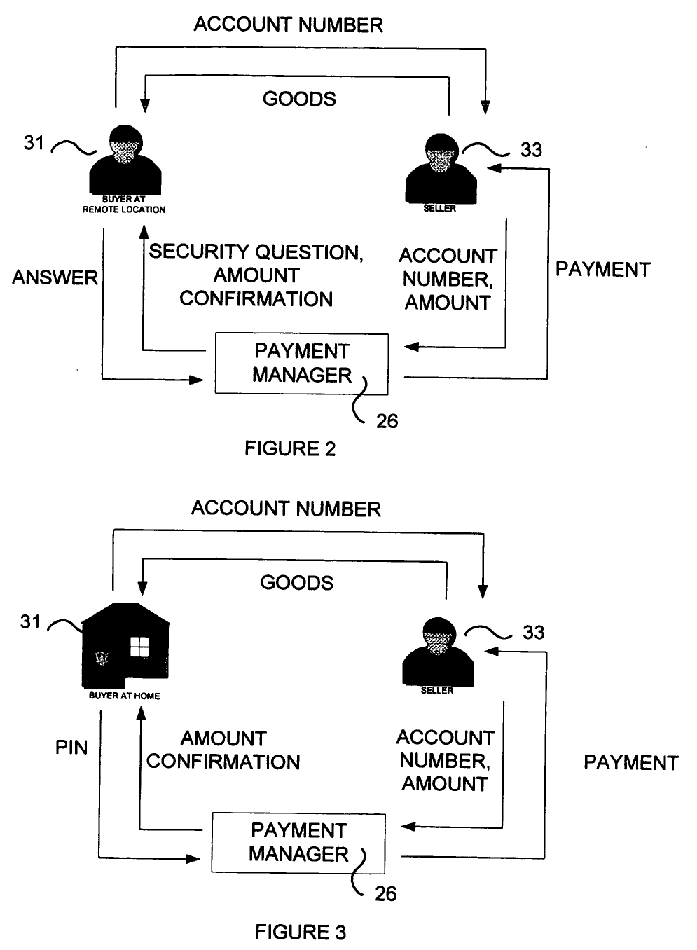

If, on the other hand, the location identification indicates that the buyer is communicating through an insecure network, as seen in FIG. 2, the payment manager 26 requests that the buyer 31 answers a security question in order to confirm the transaction. The security questions are personal questions whose answer is unlikely to be known to anyone but the buyer. The buyer sets these questions and the corresponding answers upon registering with the payment manager 26. Examples of questions include: “what is your middle name?”, “what is your dog's name?”, “what is your mother's maiden name?”, “is this your correct birthday?”, etc. In the preferred embodiment of the present invention, the questions would vary for each consecutive transaction carried over an insecure network, such that, in the case in which the answer to a security question was fraudulently intercepted by a third party, it would not be useful to answer subsequent questions. In one embodiment of the present invention, the security questions would be used only once and then would be discarded so that they may never be used again. When all security questions had been asked, the buyer would have to specify a new list of questions in the buyer account. In alternative embodiments, security questions could be repeated on a random basis, such that it would be difficult to predict when a question will be asked again.

If the security question is answered correctly by the buyer, then the payment manager 26 authorizes the transaction in a similar manner to that described above.

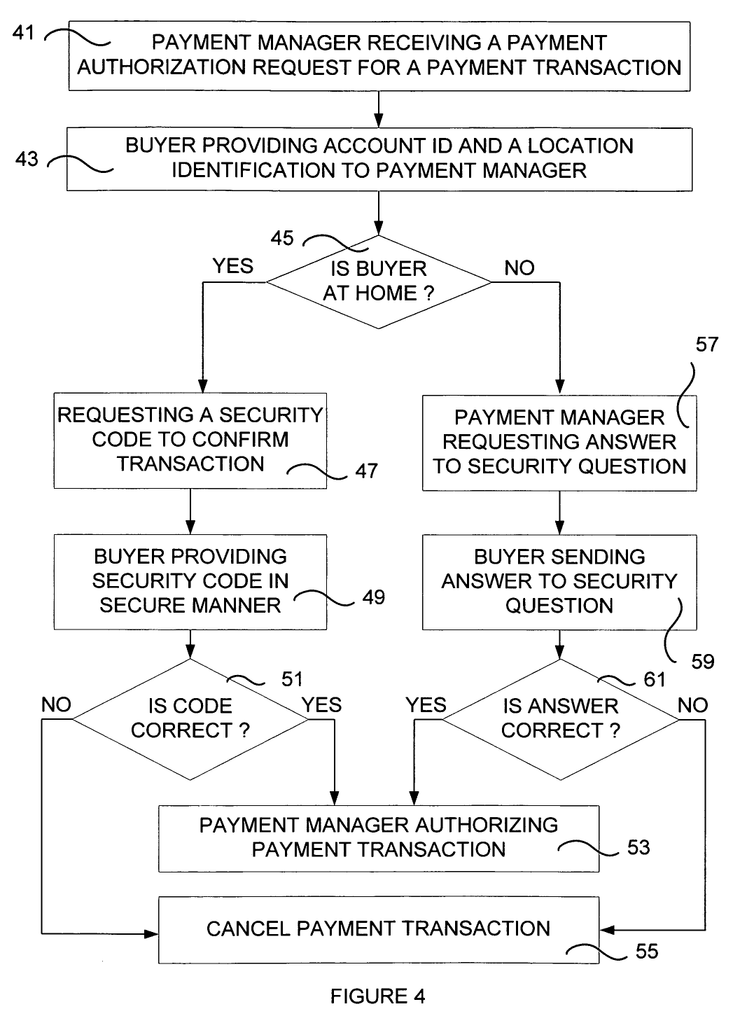

Now, with respect to FIG. 4, a method for processing a payment transaction between a buyer 31 and a seller 33 over a network using a payment manager 26, will be described. In a first step 41, the payment manager receives a payment authorization request for a payment transaction. In the preferred embodiment of the present invention, the seller 33 provides the payment authorization request to the payment manager 26, after a buyer 31 has purchased goods. In alternative embodiments of the present invention, the buyer 31 might request a payment authorization for a purchase. In a next step 43, the payment manager 26 is provided with the buyer's account ID information as well as a buyer location identification. In step 45, the payment manager 26 decides, from the location identification information received, whether the buyer 31 is at home or not, in other words, whether the buyer station 21 communicates over a secure network connection. If the location identification information, provided by the buyer, indicates that the buyer station 21 communicates over a secure network connection, the payment manager 26 will request, in step 47, that the buyer 31 provides a security code to confirm the transaction. The buyer 31 will then provide the security code in a secure manner by using the security plug in or security software installed on the buyer station 21.

The payment manager 26 then checks whether the security code provided by the buyer 31 matches the security code stored in the buyer account in the database 28. If a match exists, the payment manager takes the necessary steps in order to authorize the payment transaction. These steps include contacting the bank or credit card institution designated as payment institution in the buyer account and obtaining payment clearance, followed by forwarding the payment authorization to the seller 33.

If however, the location identification information indicates that the buyer station 21 communicates over an insecure network, the payment manager 26 will request, in step 57, that the buyer 31 provides an answer to a security question. In step 59, the buyer 59 then sends the answer over the network to the payment manager 26. The payment manager 26 compares the answer received from the buyer 31 with the answer stored in the buyer's account in the database 28. If the answer provided is correct, the payment manager 26 proceeds to obtain payment authorization in the same way as described above.

If either the security code received or the answer provided by the buyer 31 is not correct, the payment manager 26 cancels the payment transaction and sends a cancellation notice to the seller 33.

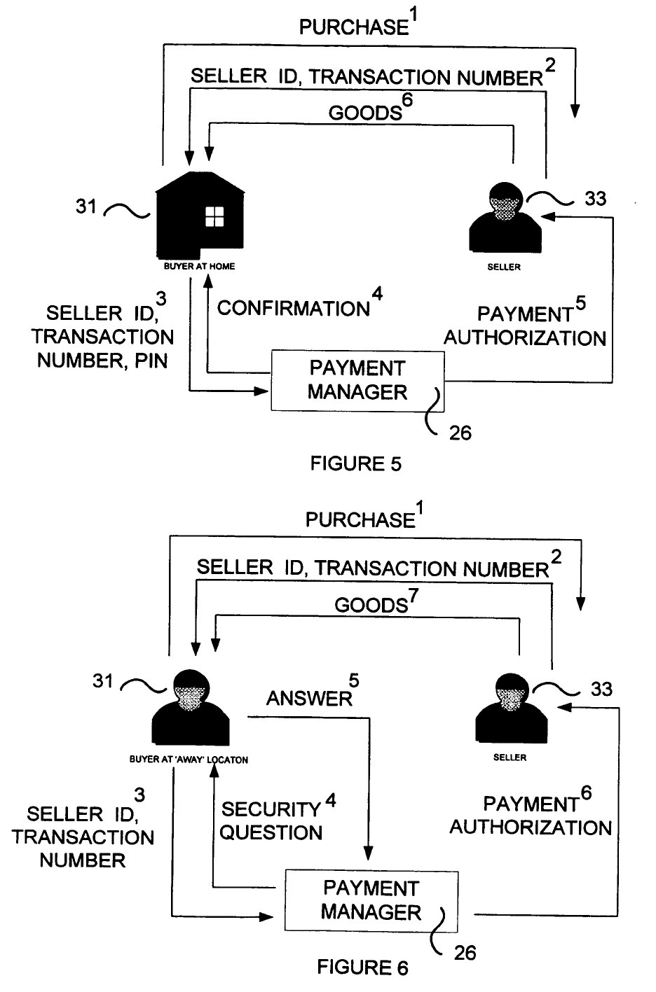

An alternative embodiment of the present invention will now be described with respect to FIG. 5. A buyer 31, from a buyer station 21 at a ‘home’ location, first visits a seller e-commerce website. At the time of checking out the purchase, the buyer 31 selects the payment manager as a payment method, in which case the seller 33 provides a transaction number and a seller ID to the buyer 31. The buyer 31 then contacts the payment manager 26 in order to obtain payment authorization for the purchase transaction. By means of email, the buyer 31 provides the seller ID and the transaction number to the payment manager 26 requesting payment transaction processing. If the PIN provided is correct, the payment manager 26 proceeds to obtain authorization for the payment transaction from the designated buyer's financial institution. After obtaining the payment authorization, the payment manager 26 uses the seller ID information to identify the seller and to provide the payment authorization for the indicated payment transaction. Upon receipt of the payment authorization, the seller 33 may send the goods to the buyer 31.

FIG. 6 illustrates an alternative embodiment of the present invention for the case in which the buyer 31 is at a buyer station 21 at an ‘away’ location. A buyer 31 first visits a seller e-commerce website. At the time of checking out the purchase, the buyer 31 selects the payment manager 26 as a payment method, in which case the seller 33 provides a transaction number and a seller ID to the buyer 31. Similarly, the buyer 31 then contacts the payment manager 26 in order to obtain payment authorization for the purchase transaction. Since the buyer is communicating from an insecure location, the communication with the payment manager 26 will not contain the digital ID certificate required for secure authentication. The payment manager 26 will then require that the buyer provides the answer to a security question in order for the purchase transaction to be processed. If the buyer provides the right answer, the payment manager 26 then proceeds to obtain authorization for the payment transaction from the designated buyer's financial institution. After obtaining the payment authorization, the payment manager 26 uses the seller ID information to identify the seller and to provide the payment authorization for the indicated payment transaction. Upon receipt of the payment authorization, the seller 33 may send the goods to the buyer 31.

While in the preferred embodiment of the present invention, the processing of a payment transaction is cancelled if the buyer fails to provide the correct confirmation information, in alternative embodiments of the present invention it could be possible to give the buyer another chance by requiring additional confirmation information. The identity of the user could indeed by validated based on rules established by the buyer and which are specified in the buyer account preferences.

Similarly, additional rules could specify that for certain types of transactions or amounts the confirmations procedures require that the user answer a plurality of security questions, or, that certain transactions are blocked.

In the preferred embodiment of the present invention, the possibility of fraud can further be reduced by instituting a two-tiered credit limit for ‘home’ and ‘away’ transactions. Preferably, the credit limits as well as any other setting to the buyer account can be modified only when the buyer communicates from the buyer station 21 at ‘home’.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

What is claimed is:

1. A method for processing a payment transaction between a buyer and a seller over a network using a payment manager, said payment manager managing a plurality of buyer accounts, each account identifying a payment modality and having an account id:
said payment manager receiving a payment authorization request for said payment transaction, including a payment amount and an identification of said seller;
said buyer providing an account id and a location identification to said payment manager;
said payment manager using said location identification to determine whether said buyer is at ‘home’;
if said location identification indicates that said buyer is at ‘home’:
said payment manager requesting that said buyer provides a security code to confirm the transaction;
said buyer providing said security code in a secure manner to said payment manager as confirmation;
if said location identification indicates that said buyer is ‘away’:
said payment manager requesting that said buyer answers at least one security question to confirm the transaction.
said buyer sending said payment manager said answer to said security question as confirmation; and
if said confirmation is correct, said payment manager authorizing said payment transaction and sending confirmation to said seller,
wherein said security code is used repeatedly for confirmation of all payment transactions for which said location identification indicates that said buyer is at ‘home’, and said at least one security question is used for payment transactions for which said location identification indicates that buyer is ‘away’.

2. A method as claimed in claim 1, wherein said security code is a PIN provided by said buyer.

3. A method as claimed in claim 1, wherein said buyer provides said requested information to said payment manager through email.

4. A method as claimed in claim 1, wherein said buyer account defines a payment limit for said ‘home’ mode and a second payment limit for said ‘away’ mode.

5. A method as claimed in claim 2, wherein said at least one security question is used only once for a payment transaction for which said location identification indicates that said buyer is ‘away’ for increased security.

6. A method as claimed in claim 1, wherein said buyer can modify said account settings only when said location identification indicates that said buyer is at ‘home’.
